(19) United States
(12) Patent Application Publication
(10) Pub. No.: US 2007/0076686 A1
(43) Pub. Date: Apr. 5, 2007

(54) Method for efficient routing in a wireless mesh network

(75) Inventor: Joo-Han Song, Yongin-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/529,669

(22) Filed: Sep. 28, 2006

(30) Foreign Application Priority Data
Sep. 30, 2005 (KR) 10-2005-092414

(51) Int. Cl. H04L 12/28; H04L 12/56

(52) U.S. Cl. 370/351; 370/400

(57) ABSTRACT

Provided is an efficient routing method for a wireless mesh network. In a method of processing routing control messages in a source node in a wireless mesh network system including the source node having transmission data and a relay node for relaying the data from the source node, the source node determines whether it is an active node knowing a path to a gateway node, upon generation of transmission data. If the source node is an active node, it determines whether it can join one of a predetermined number of logical groups. If the source node can join the group, it determines source nodes included in the remaining groups except the group that the source node can join, and sends and receives routing control messages to and from nodes other than the determined source nodes.

### PRIORITY

This application claims priority under 35 U.S.C. §119 to an application filed in the Korean Intellectual Property Office on Sep. 30, 2005 and assigned Serial No. 2005-92414, the contents of which are herein incorporated by reference.

### BACKGROUND OF THE INVENTION

1. Field of the Invention

The present invention relates generally to a mesh network, and in particular, to a method of efficiently routing data in a wireless mesh network.

2. Description of the Related Art

There are limits on the distance that a Mobile Node (MN) can transmit data wireless in a mobile communication system. In order to solve this problem, the MN can use a multi-hop scheme to communicate with another MN or a Base Station (BS) beyond its radio transmission range. Such a multi-hop communication system is a wireless mesh network. The wireless mesh network is a communication system where an MN serves as an entity for data communications and relays as well as routes traffic from one MN to another within the same network.

Therefore, the wireless mesh network facilitates network expansion to an area where a wired network is difficult to implement and it has a reliable structure because each MN is directly connected to its neighbor MNs. Hence, the number of MNs has only to be increased to increase network capacity in the wireless mesh network

FIG. 1 illustrates the configuration of a typical wireless mesh network. Referring to FIG. 1, the wireless mesh network includes a plurality of MNs and a gateway node 120 for connecting the mobile nodes to the Internet. Among the MNs, an MN 100 can communicate directly with other neighbor MNs. That is, the MN 100 can transmit data to another MN or the gateway node 120 and relay data from another MN.

For data transmission or relaying, the MNs have to be aware of a routing path. If some MN is not aware of the routing path, it transmits a Route Request (RREQ) control packet to a neighbor MN to detect the routing path. Upon receipt of the RREQ control packet, the neighbor MN determines whether the final destination of the RREQ control packet is its address. If it is, the neighbor MN transmits a Route Reply (RREP) control packet to the MN that transmitted the RREQ control packet. If the neighbor MN is not the final destination, it broadcasts an RREQ control packet attached with its address to its neighbor MNs. The first MN that transmitted the RREQ message receives the RREP control packet that has returned in the reverse path of the RREQ control packet and then recognizes the routing path based on the RREP control packet.

Consequently as more MNs exist in the wireless mesh network, collision occurs between control packets, resulting in the loss of routing control packets. The MNs have to repeat new path discovery to overcome the control packet loss. As a result, control traffic rapidly increases in the wireless mesh network.

### SUMMARY OF THE INVENTION

An object of the present invention is to substantially solve at least the above problems and/or disadvantages and to provide at least the advantages described below. Accordingly, the present invention provides a method of reducing the amount of control traffic in a wireless mesh network.

According to an aspect of the present invention, there is provided a method of processing routing control messages in a source node in a wireless mesh network system including the source node having transmission data and a relay node for relaying the data from the source node, the source node determines whether it is an active node knowing a path to a gateway node, upon generation of transmission data. If the source node is an active node, it determines whether it can join one of a predetermined number of logical groups. If the source node can join the group, it determines source nodes included in the remaining groups except the group that the source node can join, and transmits and receives routing control messages to and from nodes other than the determined source nodes.

According to another aspect of the present invention, there is provided a method of processing routing control messages in a relay node in a wireless mesh network system including a source node having transmission data and the relay node for relaying the data from the source node, the relay node receives a routing path request from a first source node and determines whether the relay node is an active node knowing a path to a gateway node. If the relay node is an active node, the relay node determines whether the source node can join one of a predetermined number of logical groups. If the source node can join the group, the relay node transmits a response for the routing path request, the response including information about the group.

According to a further aspect of the present invention, there is provided a method of processing routing control messages in a gateway node in a wireless mesh network system including a source node having transmission data, a relay node for relaying the data from the source node, and the gateway node for managing the nodes, the gateway node receives a routing path request from the source node and selects one of a predetermined number of logical groups. The gateway node then transmits a response for the routing path request, the response with the source node set as a destination and information about the selected logical group.

According to still another aspect of the present invention, there is provided a method of processing routing control messages in a source node in a wireless mesh network system including source nodes having transmission data and relay nodes for relaying the data from the source nodes, the source node sets at least one logical group including the source nodes and a division including the relay nodes, and determines whether it can join the at least one logical group. If the source node can join the logical group, it transmits and receives routing control messages to and from other source nodes belonging to the same logical group as the source node and the relay nodes belonging to the division.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical wireless mesh network;

FIG. 2 illustrates the dividing of a logical area into groups and a division in a wireless mesh network according to the present invention;

FIGS. 3A and 3B are flowcharts illustrating a data transmission operation in a source node in the wireless mesh network according to the present invention;

FIG. 4 is a flowchart illustrating a relay operation in an MN acting as a relay node in the wireless mesh network according to the present invention;

FIGS. 5A and 5B are flowcharts illustrating an operation for processing a received control packet and received data in a gateway node in the wireless mesh network according to the present invention; and

FIG. 6 is a graph comparing a routing protocol according to the present invention with conventional routing protocols in terms of performance.

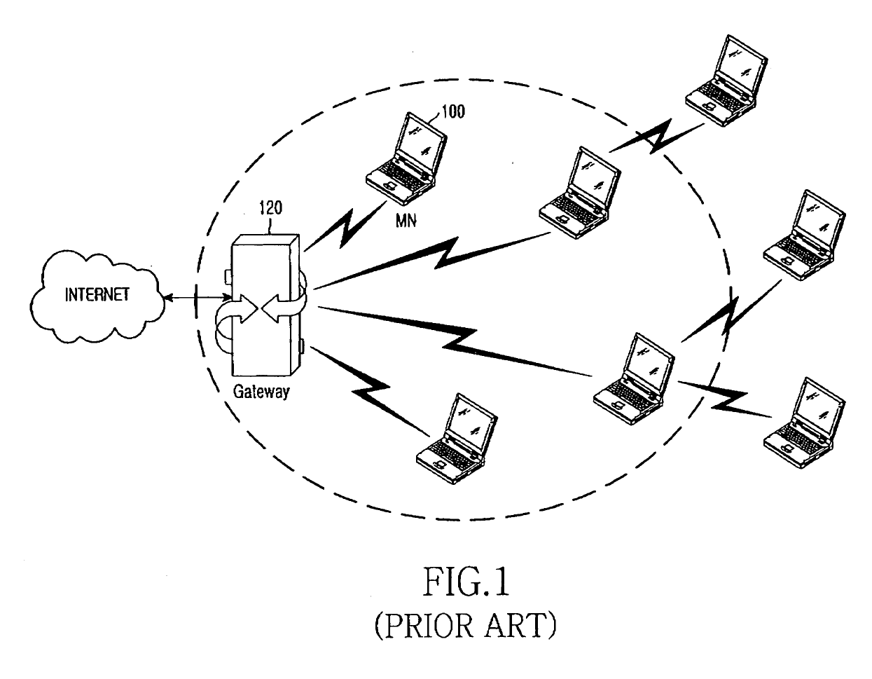

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an efficient routing method for reducing the amount of control traffic in a wireless mesh network. For this purpose, MNs are classified into different logical groups or divided according to their characteristics and an optimum routing path is selected across the groups and/or the division. Accordingly, the optimum number of groups is decided and MNs that maximize a balance index B are included in the determined groups or division.

Terms used herein are defined as follows.

Source Node: an MN that has data to be transmitted to a gateway node.

Common Node: an MN that is included in a division but not in any group. A common node does not have its own data to be transmitted and MNs other than the source node in total MNs are common nodes. Yet, the common nodes can relay data from the source node to other MNs.

Active Node: an MN which has an effective path to the gateway node.

If the source node has an effective path to the gateway node, it is at once a source node and an active node. If the common node has an effective path to the gateway node, it is at once a common node and an active node.

According to the present invention, the source node belongs to a particular group and the common node is included in a division. The group is a logical one including source nodes only and the division is a logical one including MNs other than the sources nodes, (i.e., common nodes). A control packet created from the group can be relayed by the source nodes of the group or the common nodes of the division. The classification of MNs into logical groups and division remarkably reduces the amount of control traffic.

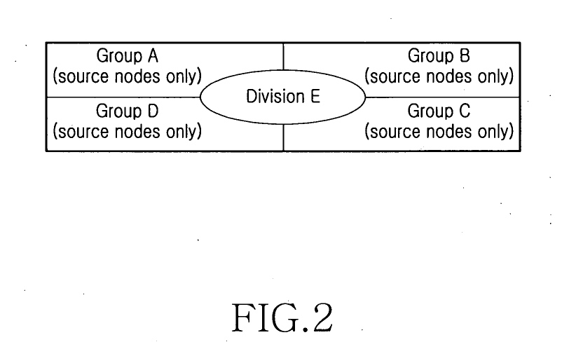

FIG. 2 illustrates the dividing of a logical area into groups and a division in a wireless mesh network according to an embodiment of the present invention. Referring to FIG. 2, in the wireless mesh network, for example a logical area is divided into four logical groups and one logical division. A source node can relay a control packet created by another source node in the same group. Common nodes in the logical division (i.e. Division E) can relay control packets from all source nodes of the four logical groups. Since another source node in the same group or a common node in the division relays an RREQ control packet created from a source node during path discovery, this grouping method leads to the decrease of the entire routing traffic.

Therefore, the number of logical groups is a critical factor in determining the efficiency of a routing protocol in the present invention. A description will thus be made of how the number of logical groups is determined.

The number of logical groups is determined in the manner that minimizes the difference between the optimum number of MNs, R maximizing resource utilization or packet transmission performance and the total number of MNs, T that can relay packets generated from each group. R is a system-preset value that offers the best performance without reducing network continuity in the wireless mesh network. T represents the total number of nodes that can relay a packet generated from each group.

Given S source nodes and M MNs in total, the total number of common nodes is (M−S). Assuming that the total number of groups is g and each group has the same number of source nodes, the number of source nodes per group is S/g where g ranges from 1 to S. Since the total number of MNs, T to relay a packet generated from each group is M−S+(S/g), a BS, that is, a gateway node determines the total number of groups that minimizes the absolute value of (T−R) is expressed in Equation (1),

$$G = {argmin}_{g ∈ \{ 1 , 2 , … S \}} \vert T - R \vert = {argmin}_{g ∈ \{ 1 , 2 , … S \}} \vert M - S + ( S / g ) - R \vert \qquad ( 1 )$$

g that minimizes Equation (1) is selected as G and the balance index B is computed by using G in Equation (2) below,

$$B = \frac{{[ {\sum }_{i = 1}^{G} {f}_{i} ]}^{2}}{G {\sum }_{i = 1}^{G} {f}_{i}^{2}} \qquad ( 2 )$$

where fᵢ represents the number of source nodes in an i^{th} group and G represents the total number of groups. The balance index B is converged to 1 when each group has the same number of source nodes. If all source nodes belong to one group, B is converged to 1/G Therefore, the number of sources nodes for each group is determined so as to maximize B in the present invention. Meanwhile, every MN has state information represented in the form of a set of (G+1) elements < group name, f₁, f₂, . . . , f_{G}>, namely (G+1)−tuple state information. This state information is broadcast from the gateway node.

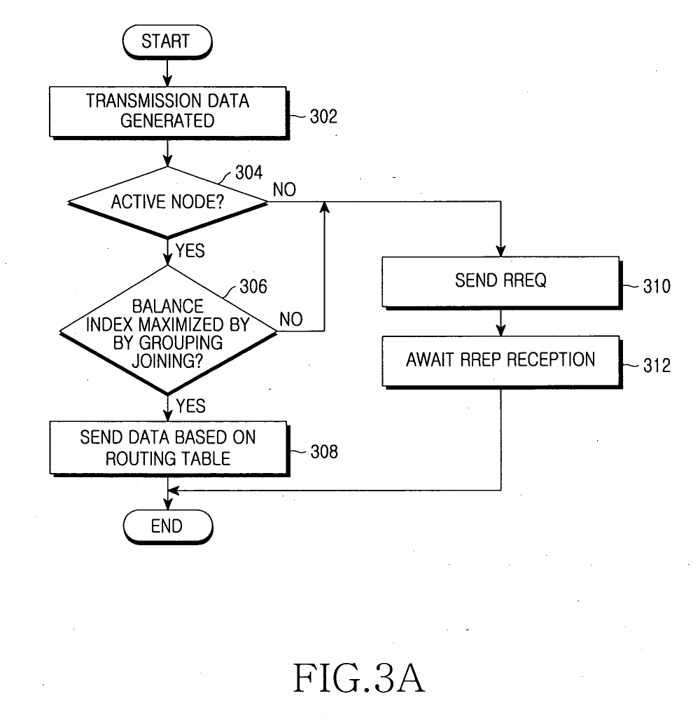

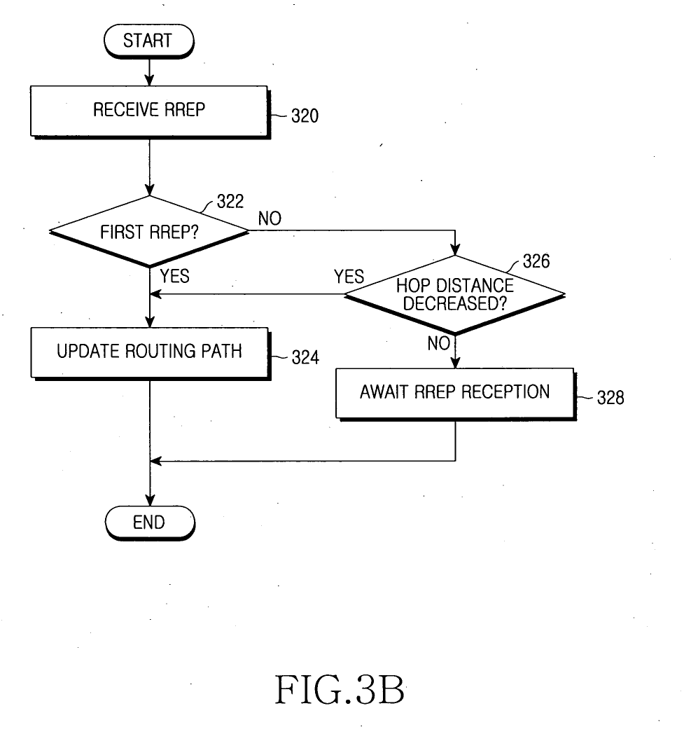

FIGS. 3A and 3B are flowcharts illustrating a data transmission operation in a source node in the wireless mesh network according tithe present invention.

FIG. 3A is a flowchart illustrating an RREQ control packet or data transmission operation in the source node, and FIG. 3B is a flowchart illustrating an RREP control packet reception operation in the source node.

Referring to FIG. 3A, the source node senses generation of transmission data in step 302. It is assumed herein that the source node is not yet in any group. In step 304, the source node determines that it is an active node having a routing path to the gateway node. If it is an active node, the source node goes to step 306 and otherwise, it proceeds to step 310.

In step 306, the source node determines whether joining an arbitrary group maximizes the balance index B. For example, if four groups are defined as illustrated in FIG. 2, the source node calculates the balance index B over the four groups and joins a group maximizing the balance index B. In step 310, if the current balance index is not higher than the previous one by joining any of the groups, the source node transmits an RREQ control packet to a neighbor MN. On the contrary, if the balance index B is maximized by joining a certain group, the source node selects the group and transmits data in a path indicated by a routing table for the selected group in step 308.

If the source node is not an active node or if the balance index B is not maximized even if the source node joins any of the groups, the source node sends the RREQ control packet to the neighbor MN in step 310, and awaits reception of an RREP control packet in the reverse path of the RREQ control packet in step 312. The RREP control packet includes information about a group that the source node will join.

Referring to FIG. 3B in step 320, the source node receive an RREP control packet for the RREQ control packet and in step 322 determines whether the RREP control packet is the first received RREP control packet in step 322. In the case of the first RREP control packet, the source node goes to step 324 and otherwise, it goes to step 326.

In the presence of a relay node or gateway node that can maximize the balance index B and receives the RREQ control packet, it transmits an RREP control packet to the source node. If at least two such relay nodes or gateway nodes exist, they transmits their RREP control packets to the source node. The first of the RREP control packets arriving at the source node is the first received RREP control packet. The source node updates path information with the first RREP control packet. Upon receipt of the second RREP control packet, the source node compares path information based on the first RREP control packet with path information based on the second RREP control packet and updates its path information to the shorted path information according to the comparison.

In step 324, the source node acquires group information and data transmission/reception path information from the RREP control packet and correspondingly updates the state information. Meanwhile, in step 326 if the hop distance of the received RREP control packet is less than that of the previous RREP control packet, the source node updates the routing path and group information correspondingly in step 324. However, if the hop distance of the received RREP control packet is equal to or greater than that of the previous RREP control packet in step 326, the source node awaits reception of a new RREP control packet in step 328.

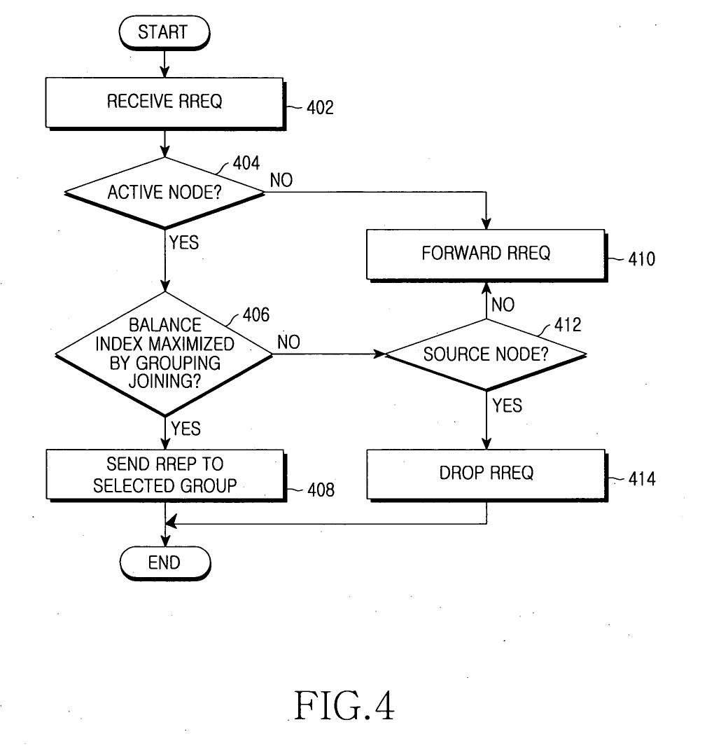

FIG. 4 is a flowchart illustrating a relay operation in an MN acting as a relay node in the wireless mesh network according to the present invention.

Referring to FIG. 4, the MN receives an RREQ control packet from a source node in step 402 and determines that it is an active node being ware of a path to the gateway node in step 404. If it is an active node, the MN goes to step 406 and if it is not an active node, the MN proceeds to step 410.

In step 406, the MN calculates a balance index based on its state information. If joining the source node in a particular group maximizes the balance index, the MN goes to step 408 and otherwise, it goes to step 412.

The MN selects the particular group and transmits an RREP control packet to the selected group in step 408. In step 410, the MN that is not an active node forwards the RREQ packet to a neighbor MN.

In step 412, the MN determines whether it is a source node. If it is a source node, the MN proceeds to step 414. If it is not a source node, the MN goes to step 410. In step 414, the MN drops the received RREQ packet without transmitting it to any other MN, considering that it is a source node belonging to a different group from that of the source node that has transmitted the RREQ control packet.

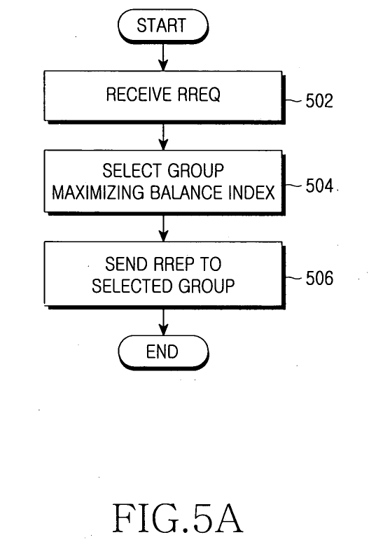

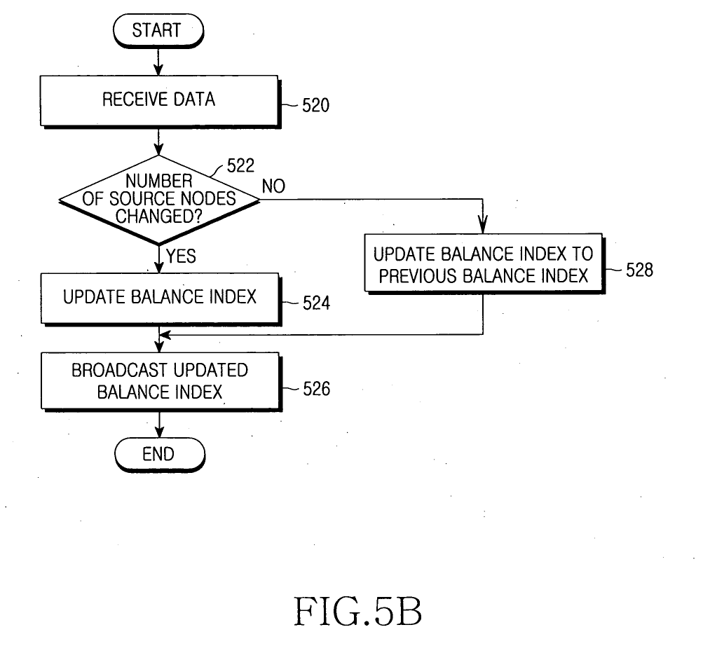

FIGS. 5A and 5B are flowcharts illustrating an operation for processing a received control packet and received data in the gateway node in the wireless mesh network according to the present invention.

FIG. 5A is a flowchart illustrating an operation for processing a received RREQ control packet in the gateway node and FIG. 5B is a flowchart illustrating an operation for processing received data in the gateway node.

Referring to FIG. 5A, in step 502 upon receipt of an RREQ control packet from an MN, in step 504 the gateway node selects a group maximizing the balance index. In step 506, the gateway node transmits an RREP control packet with a source node set as a destination address to the MN that has received the RREQ control packet in step 506. The RREP control packet includes information about a group that the source node will join.

Referring to FIG. 5B, in step 520 upon receipt of data whose destination is the gateway node from a source node, in step 522 the gateway node determines whether the total number of source nodes in the network has been changed. If the number of source nodes has been changed, the gateway node goes to step 524 and if the number of source nodes has not been changed, the gateway node proceeds to step 528. In step 524, the gateway node updates the balance index according to Equation (2). Then the gateway node broadcasts the updated balance index to all active nodes in step 526. In step 528, the gateway node updates the balance index to the previous balance index.

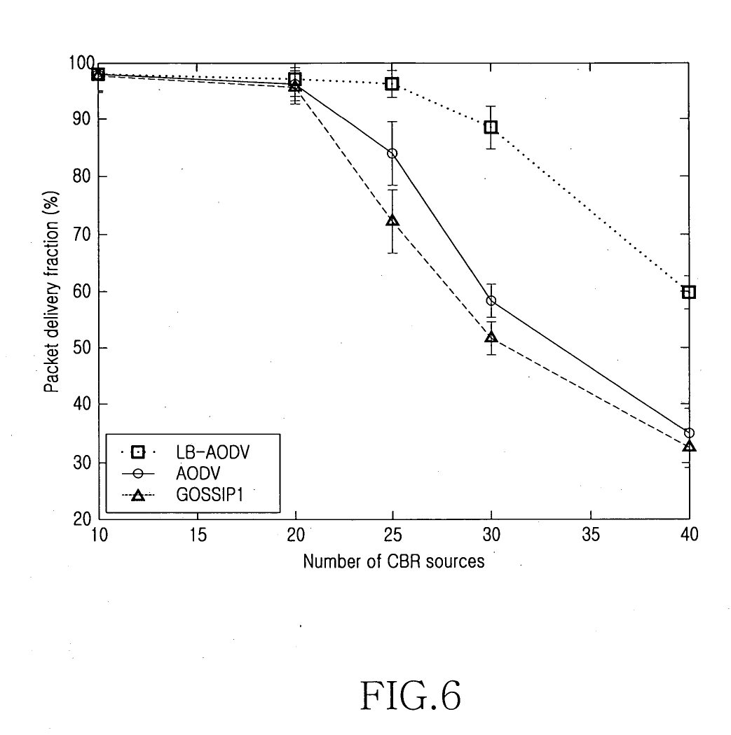

FIG. 6 is a graph comparing the routing protocol according to the present invention with conventional routing protocols in terms of performance. Referring to FIG. 6, a wireless mesh network using the routing protocol of the present invention (LB-AODV) outperforms wireless mesh networks using conventional routing protocols (AODV and GOSSIP) by 30% in packet delivery fraction. Thus, it can be concluded that Internet service providers can service more users with the same cost using the present invention.

As described above, the present invention advantageously decreases the total system traffic by reducing the number of transmissions of routing control messages for path discovery. The resulting extra radio resources can be utilized for data communications and Internet service providers can provide services to more users with the same cost.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of processing routing control messages in a source node in a wireless mesh network system including the source node having transmission data and a relay node for relaying the data from the source node, comprising the steps of:
determining whether the source node is an active node knowing a path to a gateway node, upon generation of transmission data;
determining whether the source node can join one of a predetermined number of logical groups, if the source node is an active node; and
determining, if the source node can join the group, source nodes included in the remaining groups except the group that the source node can join, and transmitting and receiving routing control messages to and from nodes other than the determined source nodes.

2. The method of claim 1, further comprising:
requesting a routing path to a neighbor node, if the source node is not an active node; and
receiving a response for the routing path request from the neighbor node, the response including information about a logical group to be joined and the numbers of source nodes included in the logical groups.

3. The method of claim 1, wherein the number of the logical groups, G is determined by
$$G = {argmin}_{g ∈ \{ 1 , 2 , … S \}} \vert T - R \vert = {argmin}_{g ∈ \{ 1 , 2 , … S \}} \vert M - S + ( S / g ) - R \vert$$
where T represents the total number of nodes that can relay a packet generated from each group, R represents a predetermined optimum number of nodes that maximizes one of a resource utilization and packet transmission performance, M represents the total number of nodes, and S represents the number of source nodes.

4. The method of claim 1, wherein the step of determining whether the source node can join one of the logical groups, taking into account of a balance index, B expressed by
$$B = \frac{{[ {\sum }_{i = 1}^{G} {f}_{i} ]}^{2}}{G {\sum }_{i = 1}^{G} {f}_{i}^{2}}$$
further comprises joining a group that makes the balance index B exceed a previous balance index B,
$$B = \frac{{[ {\sum }_{i = 1}^{G} {f}_{i} ]}^{2}}{G {\sum }_{i = 1}^{G} {f}_{i}^{2}}$$
where fᵢ represents the number of source nodes in an i^{th} group.

5. A method of processing routing control messages in a relay node in a wireless mesh network system including a source node having transmission data and the relay node for relaying the data from the source node, comprising the steps of:
receiving a routing path request from a first source node;
determining whether the relay node is an active node knowing a path to a gateway node;
determining whether the source node can join one of a predetermined number of logical groups, if the relay node is an active node; and
transmitting, if the source node can join the group, a response for the routing path request, the response including information about the group.

6. The method of claim 5, further comprising:
determining whether the relay node is a second source node, if the first source node can join none of the logical groups; and
not processing the routing path request from the first source node, if the relay node is the second source node.

7. The method of claim 5, wherein the number of the logical groups, G is determined by
$$\begin{matrix}G = \begin{matrix}{argmin}_{g ∈ \{ 1 , 2 , … S \}} \vert T - R \vert & 10\end{matrix} \\ = {argmin}_{g ∈ \{ 1 , 2 , … S \}} \vert M - S + ( S / g ) - R \vert\end{matrix}$$
where T represents the total number of nodes that can relay a packet generated from each group, R represents a predetermined optimum number of nodes that maximizes resource utilization or packet transmission performance, M represents the total number of nodes, and S represents the number of source nodes.

8. The method of claim 5, wherein the step of determining whether the source node can join one of the logical groups, taking into account of a balance index, B expressed by
$$B = \frac{{[ {\sum }_{i = 1}^{G} {f}_{i} ]}^{2}}{G {\sum }_{i = 1}^{G} {f}_{i}^{2}}$$
further comprises joining the first source node in a group that makes the balance index B exceed a previous balance index B,
$$B = \frac{{[ {\sum }_{i = 1}^{G} {f}_{i} ]}^{2}}{G {\sum }_{i = 1}^{G} {f}_{i}^{2}}$$
where fᵢ represents the number of source nodes in an i^{th} group.

9. A method of processing routing control messages in a gateway node in a wireless mesh network system including a source node having transmission data, a relay node for relaying the data from the source node, and the gateway node for managing the nodes, comprising the steps of:
receiving a routing path request from the source node;
selecting one of a predetermined number of logical groups; and
transmitting a response for the routing path request, the response with the source node set as a destination and information about the selected logical group.

10. The method of claim 9, further comprising:
determining whether the number of source nodes has been changed, upon receipt of data from the source node;
updating a balance index considered to distribute the source nodes to the logical groups, if the number of the source nodes has been changed; and
broadcasting the updated balance index.

11. The method of claim 10, wherein the balance index B is determined by
$$B = \frac{{[ {\sum }_{i = 1}^{G} {f}_{i} ]}^{2}}{G {\sum }_{i = 1}^{G} {f}_{i}^{2}}$$
where fᵢ represents the number of source nodes in an i^{th} group and G is the number of the logical groups.

12. The method of claim 9, wherein the number of the logical groups is determined by
$$G = {argmin}_{g ∈ \{ 1 , 2 , … S \}} \vert T - R \vert = {argmin}_{g ∈ \{ 1 , 2 , … S \}} \vert M - S + ( S / g ) - R \vert$$
where T represents the total number of nodes that can relay a packet generated from each group, R represents a predetermined optimum number of nodes that maximizes resource utilization or packet transmission performance, M represents the total number of nodes, and S represents the number of source nodes.

13. A method of processing routing control messages in a source node in a wireless mesh network system including source nodes having transmission data and relay nodes for relaying the data from the source nodes, comprising the steps of:
setting at least one logical group including the source nodes and a division including the relay nodes, and determining whether the source node can join the at least one logical group; and
transmitting and receiving routing control messages to and from other source nodes belonging to the same logical group as the source node and the relay nodes belonging to the division, if the source node can join the logical group.

14. The method of claim 13, further comprising the step of, upon generation of transmission data, determining whether the source node is an active node knowing a path to a gateway node.

15. The method of claim 14, further comprising, the if the source node is not an active node the steps of:
requesting a routing path to a neighbor node; and
receiving a response for the routing path request from the neighbor node, the response including information about a logical group to be joined and the number of the source nodes included in the at least one logical group.

16. The method of claim 13, wherein the number of the at least one logical group, G is determined by
$$\begin{matrix}G = {arg min}_{g ∈ \{ 1 , 2 , … S \}} \vert T - R \vert \\ = {arg min}_{g ∈ \{ 1 , 2 , … S \}} \vert M - S + ( S / g ) - R \vert\end{matrix}$$
where T represents the total number of nodes that can relay a packet generated from each group, R represents a predetermined optimum number of nodes that maximizes resource utilization or packet transmission performance, M represents the total number of nodes, and S represents the number of source nodes.

17. The method of claim 13, wherein the step of determining whether the source node can join the at least one logical group, taking into account of a balance index, B expressed in the following equation, further comprising joining a group that makes the balance index B exceed a previous balance index B,
$$B = \frac{{[ {\sum }_{i = 1}^{G} {f}_{i} ]}^{2}}{G {\sum }_{i = 1}^{G} {f}_{i}^{2}}$$
where fᵢ represents the number of source nodes in an i^{th} group and G represents the number of the at least one logical group.
